(19) United States
(12) Patent Application Publication
(10) Pub. No.: US 2006/0170294 A1
(43) Pub. Date: Aug. 3, 2006

(54) Heat dissipation structure of a motor

(76) Inventor: Alex Du, Taichung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/045,285

(22) Filed: Jan. 31, 2005

(51) Int. Cl. H02K 9/00; H02K 9/06

(52) U.S. Cl. 310/63; 310/58; 310/261

(57) ABSTRACT

A motor is disclosed to have a plurality of wind holes formed in the transverse top wall and peripheral wall of the hollow cylindrical body of the rotor thereof, dividing the transverse top wall into a plurality of equiangularly spaced and radially extended fan blade portions and the upper part of the peripheral wall into a plurality of equiangularly spaced tangential peripheral wall portions for inducing currents of air to dissipate heat upon rotation of the rotor relative to the stator and the casing.

### BACKGROUND OF THE INVENTION

1. Field of the Invention

The present invention relates to a motor and more specifically, to the heat dissipation structure of a motor.

2. Description of the Related Art

In order to dissipate heat from a motor, an external fan may be used. Alternatively, a fan blade may be fastened to the shaft of a motor so that the fan blade causes currents of air to carry heat away from the motor during rotation of the motor shaft. These two conventional heat dissipation measures require much external installation space for the fan or internal installation space for the fan blade. Further, the installation of the fan or the fan blade greatly increases the cost.

### SUMMARY OF THE INVENTION

The present invention has been accomplished under the circumstances in view. It is the main object of the present invention to provide a heat dissipation structure for motor, which efficiently dissipates heat from the motor during its operation. It is another object of the present invention to provide a heat dissipation structure for motor, which does not increase the size of the motor. To achieve these and other objects of the present invention, the heat dissipation structure of the motor comprises a plurality of wind holes formed in the transverse top wall and peripheral wall of the hollow cylindrical body of the rotor of the motor, dividing the transverse top wall into a plurality of equiangularly spaced and radially extended fan blade portions and the upper part of the peripheral wall into a plurality of equiangularly spaced tangential peripheral wall portions for inducing currents of air to dissipate heat upon rotation of the rotor relative to the stator and the casing.

### BRIEF DESCRIPTION OF THE DRAWINGS

FIG. 1 is an exploded view of a motor according to the present invention.

FIG. 2 is a side view in section of the motor according to the present invention.

FIG. 3A is a front view in section of the present invention, showing the motor in action.

FIG. 3B is a side view of FIG. 3A.

### DETAILED DESCRIPTION OF THE PREFERRED EMBODIMENT

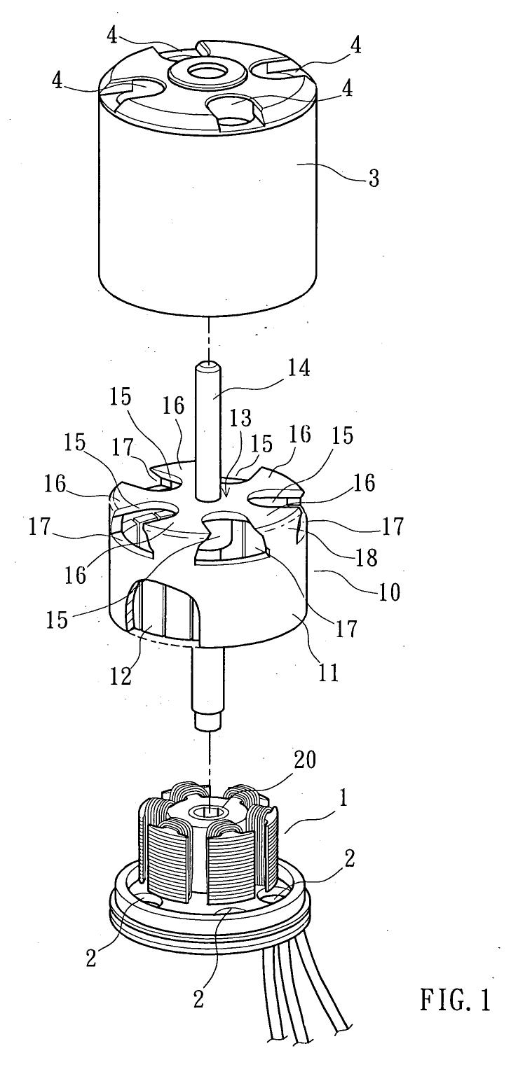

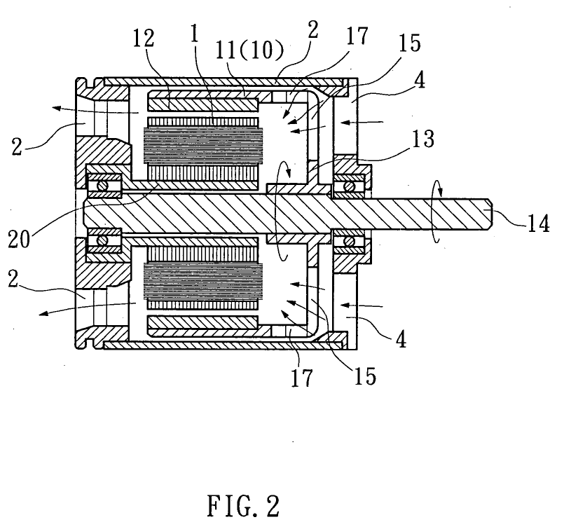

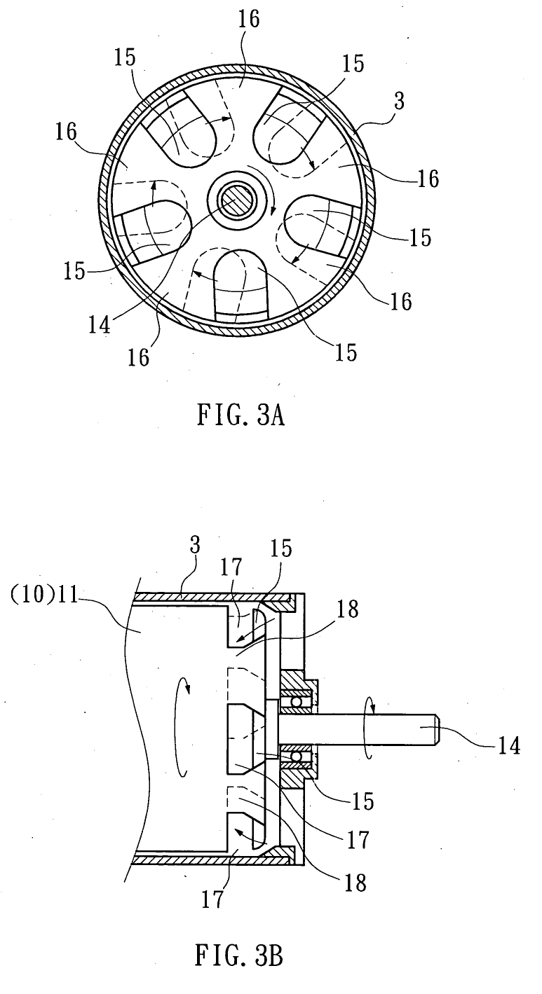

Referring to FIGS. 1, 2, 3A and 3B, a motor is shown comprising a stator 1, a rotor 10, and a casing 3 accommodating the stator 1 and the rotor 10.

The rotor 10 comprises a hollow cylindrical body 11 made from a metal material, and a plurality of magnets 12 fixedly fastened to the inside wall thereof. The hollow cylindrical body 11 has a bottom open end, a top close end formed of a transverse top wall 13 for the mounting of a shaft 14, a plurality of top wind holes 15 equiangularly formed in the transverse top wall 13 and dividing the transverse top wall 13 into a plurality of equiangularly spaced and radially extended fan blade portions 16, a plurality of peripheral wind holes 17 equiangularly spaced around the periphery and respectively disposed in communication with the top wind holes 15 and dividing the upper part of the periphery of the hollow cylindrical body 11 into a plurality of equiangularly spaced tangential peripheral wall portions 18 respectively connected to the fan blade portions 16 at right angles.

The stator 1 has a plurality of air holes 2 equiangularly spaced around the bottom wall thereof and a center winding holder 20 vertically disposed at the center of the bottom wall for holding windings.

The casing 3 has a plurality of air holes 4 equiangularly formed in the top wall thereof.

Further, the stator 1 is fixedly mounted inside the casing 3. The stator 1 is suspended inside the casing 3, holding the magnets 12 spaced around the windings at the winding holder 20 of the rotor 10. When electrically connected, the windings of the rotor 10 produce a magnetic field to act against the magnets 12, thereby causing the rotor 10 to rotate relative to the stator 1 and the casing 3.

During rotation of the rotor 10, the tangential peripheral wall portions 18 and the fan blade portions 16 induce currents of air, enabling induced currents of air to pass through the wind holes 15;17 of the rotor 10 and the air holes 2 of the stator 1 to the outside of the motor and to simultaneously carry heat away from the motor.

A prototype of heat dissipation structure of a motor has been constructed with the features of FIGS. 1-3. The heat dissipation structure of a motor functions smoothly to provide all the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A motor comprising a casing, a stator fixedly mounted inside said casing, and a rotor suspending inside said casing and rotatable relative to said stator and said casing, wherein said rotor comprises a hollow cylindrical body made from a metal material, said hollow cylindrical body having a bottom open end, a top close end formed of a transverse top wall, a plurality of top wind holes equiangularly formed in said transverse top wall and dividing said transverse top wall into a plurality of equiangularly spaced and radially extended fan blade portions for inducing currents of air upon rotation of said rotor relative to said stator and said casing.

2. The motor as claimed in claim 1, wherein said hollow cylindrical body of said rotor further comprises a plurality of peripheral wind holes equiangularly spaced around the periphery thereof and respectively disposed in communication with said top wind holes and dividing an upper part of the periphery into a plurality of equiangularly spaced tangential peripheral wall portions respectively connected to said fan blade portions at right angles.

3. The motor as claimed in claim 1, wherein said stator has a plurality of air holes adapted to guide currents of said from the top wind holes and peripheral wind holes of said rotor to the outside of the motor.
